(19) United States
(12) Patent Application Publication
(10) Pub. No.: US 2014/0089125 A1
(43) Pub. Date: Mar. 27, 2014

(54) TRADING UP SOCIAL NETWORK ENGINE

(71) Applicant: Marlina Stacey KINNERSLEY, Toronto (CA)

(72) Inventor: Marlina Stacey KINNERSLEY, Toronto (CA)

(21) Appl. No.: 14/037,027

(22) Filed: Sep. 25, 2013

Related U.S. Application Data
(60) Provisional application No. 61/706,159, filed on Sep. 27, 2012.

(51) Int. Cl. G06Q 50/00; G06Q 30/08

(52) U.S. Cl. CPC G06Q 50/01; G06Q 30/08
USPC 705/26.3

(57) ABSTRACT

A computer implemented trading engine is disclosed. The trading engine is configured to connect with a plurality of computing devices and a plurality of servers; said trading engine further configured to manage trading circles between accounts maintained in association with at least two of said computing devices, said engine trading further configured to manage a first electronic data message representing at least one offer and at least one additional electronic data message representing an accepted trade proposal for said at least one offer.

### FIELD OF THE INVENTION

The present specification relates generally to computing devices and methods and more specifically relates to computing devices for connecting to social networks and methods of using social networks.

### BACKGROUND

Although numerous e-commerce listing and auction applications and services exist, these applications and services have not effectively addressed issues associated with establishing credibility or facilitating trust for a given trade transaction. In particular, the use of social data including the use of semantic analysis, preference analysis and sentiment analysis, or the use of the social graph that defines the network of connections and relationships between individuals or entities has not been effectively applied in the context of facilitating trade and e-commerce transactions.

### SUMMARY

In accordance with an aspect of the invention, there is provided a method and system that leverages a social network and associated social graph to effectively establish credibility and trust between two parties of a given trade transaction as well as to increase the efficiency and effectiveness of a trading/bartering method and system. The disclosed method and system leverages the social network and associated social data including the social graph to facilitate trades and commerce between two or more parties. The disclosed method and system also encourages trades via messages, notifications, and promotions including but not limited to e-mails and messages to a parties on the system, visual indicators which can be accessed and viewed by a computing device (e.g. computer, tablet, smartphone etc.), and awards (e.g. a tangible reward which can be distributed to a party on the system, or a reduction in applicable charges associated with the use of the system, credits which can be applied for use of the system, or a monetary amount which can be applied against an account etc.).

The present specification can provide, amongst other things:

a. A method and system for trading between two or more users on a social network worldwide.
b. A method and system to facilitate multi-party trades within a social network on the Internet. The social network would specifically be leveraged to efficiently and effectively determine potential trades between two or more participants of the system given their social proximity as well as other information (e.g. offer, wishlist, and interest information).
c. A method and system to import posts from other barter and e-commerce platforms.

In aspects of this specification, there is provided, a computerized classified listing system that facilitates trade or e-commerce transactions between 2 or more parties, each having at least one item available for trade (or sale) on the network. In a non-limiting embodiment, a computerized classified listing system that facilitates trades or e-commerce transactions between 2 or more parties where at least one party does not have an item for trade or sale. Users will create a new offer by uploading photos, writing a description and selecting a category. This will make browsing and search within the database efficient. Users will create a wishlist, items that they want to acquire for their trade up journey or to keep. With users' offerings and wishlists the automated trading engine can create suggested trade transactions between two or more users.

In aspects of this specification:

a. Users will select a Kiinzel Dream or pre-determined end goal for their trade up journey. The steps in selecting a Kiinzel Dream are similar to the steps associated with establishing an offer. The user will upload a photo of their Kiinzel Dream, create a description and share why they want this particular end goal. The system will make trade or purchase recommendations based on their geographical area (using location determining technology (e.g. GPS, reverse IP geo-mapping etc.)) and their trading circle or social network. Trade or matching recommendations will have the effect of facilitating efficient trade or e-commerce transactions.
b. When a user creates a new offer, they will be optionally able to import an existing ad or post from another platform. The available images, description and if possible the category will be imported and converted so that it is compatible with the data structures used by the method and system. Users will be prompted to optionally remove the user' listing on the other e-commerce or bartering platform to avoid confusion or potential conflicts. Alternatively, the method and system will automatically delete the listing the user's listing on the other e-commerce or bartering platform to avoid confusion or potential conflicts.
c. Once a trade or sale has been completed, both users ship their respective items or make other suitable arrangements to exchange items (e.g. to meet in person to trade items or to exchange an item for the consideration of currency). The system may record shipping arrangements for tracking purposes. Once both parties have received their trade items in the event of a trade transaction (or a purchaser has received a purchased item in the event of a sell transaction), the parties may provide a review for each other. The system may provide a rating or score for each party based on an algorithm (e.g. based on the number of transactions, positive/negative feedback received, semantic/sentiment analysis of provided review text etc.). The rating or score will increase engagement, credibility, and trust for users of the platform by providing a quantified or qualified (e.g. a visual indicator) that provides an indication of the reputation of a given user of the trading engine.

In aspects of this specification, there is also provided:

a. A method and system for implementing and coordinating trades or transactions between 2 or more parties each having one or more items for trade or sale, via the communications network, which is preferably the Internet, mobile, or wireless network. In a non-limiting embodiment, the method and system implements and coordinates trades or transactions between 2 or more parties where at least one party does not have an item for trade or sale.
b. A method and system for efficient browsing and searching within a database.
c. A method and system for finding the best or otherwise suitable match between two or more trade offers.
d. A method and system for tracking applicable transaction details including payment, location, date, and shipment data of traded items between users involved in the trade or sale.

In aspects of this specification:

a. The platform can facilitate trades or transactions of a wide range of tangible goods and services including items from different product/service categories.
b. The website design and implementation, including UX/UI (User Experience/User Interface) can vary widely throughout the platform's evolution. The platform will allow users to sign up or sign in, post items for barter or sale, identify their wishlist, add their social networks, browse or search the database for items of interest as well as their social friends or other potential traders, identify users' locations via location determining technology (e.g. GPS, reverse IP geo-mapping etc.), identify their current trade up goal (target wish) or Kiinzel Dream, and trade, and review or rate a given user upon a trade/purchase transaction.
c. Non-registered users may browse and search for items to see what is on the platform in their area using location determining technology (e.g. GPS, reverse IP geo-mapping etc.); they will also be able to search for people which will provide generalized or snapshot search results. Registration may be required to view the detailed version of the offers, to create a post, to make an offer for trade or purchase, to invite their friends/add friends to the platform or to view a user's profile page or store. Registration could be free, or for a fee, or some other consideration.
d. A user can register, sign-up, and authenticate via their existing social networks. For example, Facebook or Twitter. A user may also signup with his/her email address and by creating a password.
e. Trade Listing—user creates a new listing, uploads one or more pictures, writes a description, selects a category and includes tags for better searchability. Trade/Sell Listing will allow user to accept either a trade or sale offer. Sale Listing allows the user to strictly sell the item on the platform.
f. The more listings a trader creates, the more likely a trade up transaction will occur towards their Kiinzel Dream (target goal or wish).
g. A user's interests and wishlist serves to increase the probability of a successful trade match through our system's ability to make trade suggestions.

### BRIEF DESCRIPTION OF THE DRAWINGS

Reference will now be made, by way of example only, to the accompanying drawings in which:

FIG. 1 is a schematic block diagram of the components of a system in accordance with an embodiment;

FIG. 2 is a schematic block diagram of the components of a computing device in accordance with the embodiment of FIG. 1;

FIG. 3 is a schematic block diagram of the components of a trading engine in accordance with the embodiment of FIG. 1; and

FIG. 4 is a flow chart of a method in accordance with an embodiment.

### DETAILED DESCRIPTION

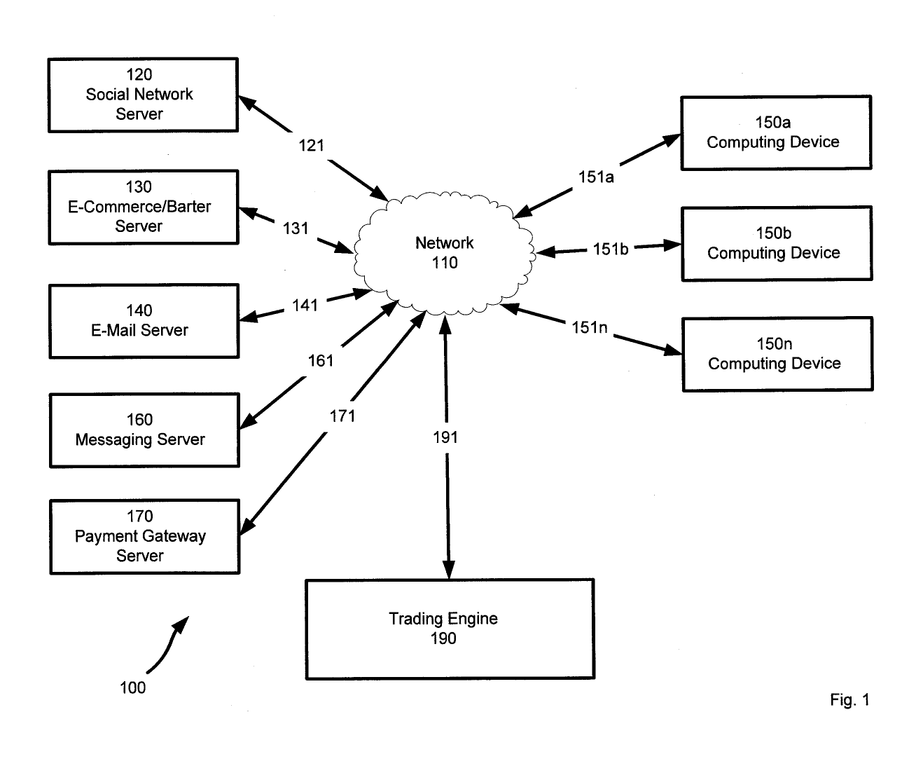

Referring to FIG. 1, System 100 includes a plurality of servers 120, 130, 140, 160, 170 and so on (collectively referred to as servers and generically, as a server). Each server can be based on any known server environment. As such, each server includes one or more processors, volatile (e.g. Random Access Memory (“RAM”)) and/or non-volatile (e.g. read only memory (“ROM”), Electrically Erasable Programmable Read Only Memory (“EEPROM”), flash memory, magnetic computer storage device, or optical disc) memories and one or more communications interfaces for interconnecting with network 110 via links 121, 131, 141, 161, and 171 (collectively referred to as links and generically, as a link). Links can be, for example, wired or wireless links. Servers can be managed by way of input and output devices (not shown) such as keyboards and displays. Such input and output devices can be co-located with servers or can be located at terminals (not shown) remote from servers and connected to servers via network 110.

System 100 includes a plurality of computing devices 150a, 150b, 150n (collectively referred to as computing devices 150 and generically, as a computing device 150). Computing devices 150 connect via with network 110 via links 151a, 151b, 151n (collectively referred to as links and generically, as a link 151). Computing devices 150 can be a desktop computer, a laptop, a tablet computer, a smart phone, a personal digital assistant (PDA), or any other suitable computing device.

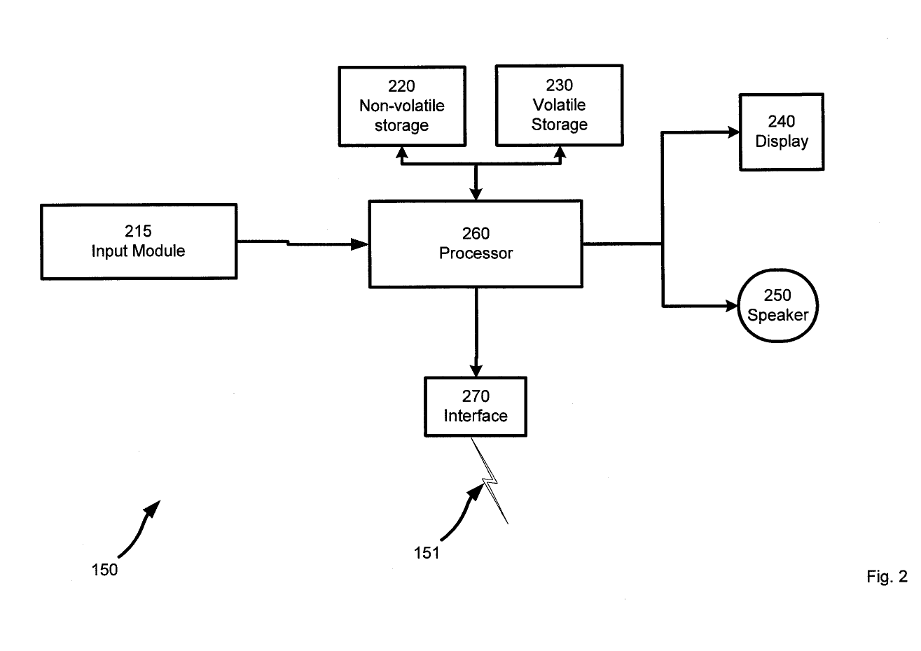

Referring to FIG. 2, the computing device 150 includes a processor 260; input module 215 which may include a keyboard, a mouse, a touch screen, a camera, a microphone, a barcode scanner, and/or the like; output devices which may include a display 240 and/or speaker 250; and an interface module 270. The components and modules of computing device 150 may send signals to each other. For example, the processor 260 can send a signal to the display 240 to cause the display 240 to display a visual indicator. The processor 260 can be any suitable processing device configured to run and/or execute modules, functions, and/or processes associated with displaying a visual indicator. The processor 260 can be a general purpose processor, a Field Programmable Gate Array (FPGA), an Application Specific Integrated Circuit (ASIC), a Digital Signal Processor (DSP), and/or the like. In some embodiments, the computing device 150 can include one or more hardware-based modules (e.g., DSP, FPGA, ASIC) and/or software-based modules (e.g., a module of computer code to be executed at a processor, a set of processor-readable instructions that can be executed at a processor) associated with executing an application, such as, for example, a web browser application operable to display a visual indicator (not shown). The processor 260 can be configured to retrieve data from and/or write data into the volatile storage 230 and/or non-volatile storage 220 (collectively referred to as memory). The memory can be, for example, a random access memory (RAM), a memory buffer, a hard drive, a database, an erasable programmable read only memory (EPROM), an electrically erasable programmable read only memory (EEPROM), a read only memory (ROM), a flash memory, a hard disk, a floppy disk, and/or so forth. In some embodiments, memory can store instructions operable to cause the processor 260 to execute modules, processes, and/or functions associated with displaying a visual indicator, for example, in a web browser application (not shown). The processor 260 can be configured to control operation of the interface module 270. The interface module 270 can be configured to operatively and/or communicatively couple the computing device 150 to the network 110 and/or to devices similarly connected to the network 110 via link 151. The interface module 270 can be software and/or hardware associated with, for example, a Network Interface Controller (NIC), a cellular telephone radio, and/or any other suitable network access hardware and/or software (executing in hardware). Link 151 is compatible with network 110. In some embodiments, link 151 is a wired link and in other embodiments it is a wireless link. It will be understood that interface module 270 can therefore be selected for compatibility with link 151 as well as with network 110.

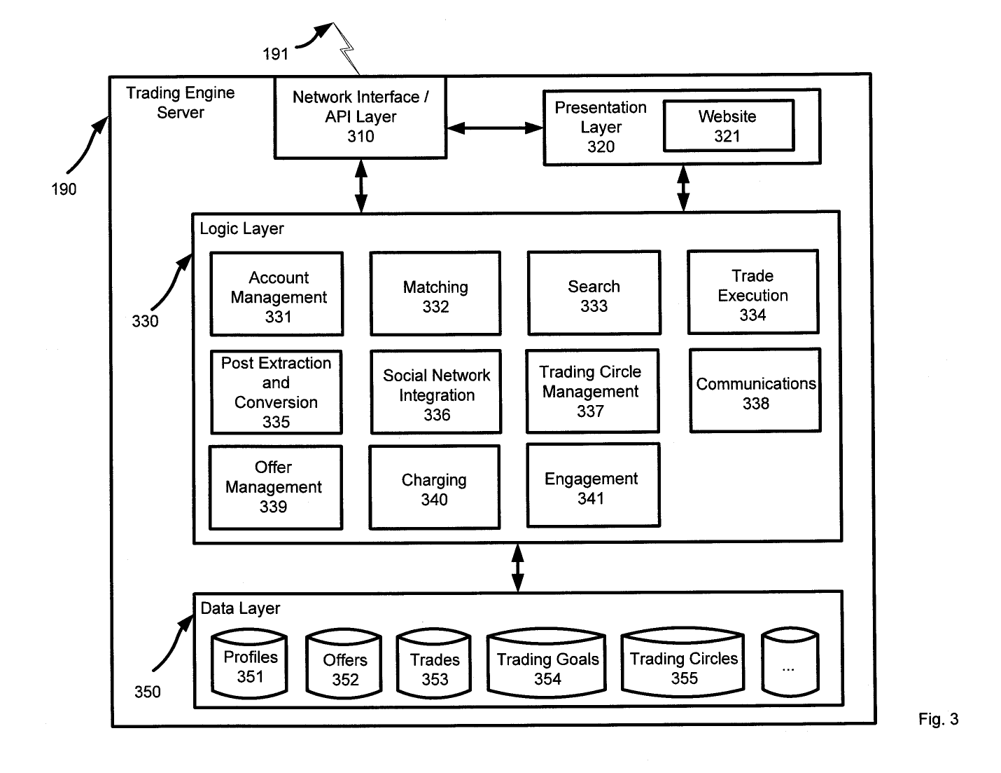

Referring to FIGS. 1 and 3, in a non-limiting embodiment, an application resident on computing device 150 may interact with trading engine 190 for the purpose of facilitating entry or modification of data or execution of a given trade or sale. For example an application resident on computing device 150 may facilitate the entry of wishlist data via the account management module 331 of trading engine 190, the entry of offer information via the offer management module 339 of trading engine 190, to execute a trade or sale via the trade execution module 334 of trading engine 190. It will be evident to those skilled in the art that an application resident on computing device 150 may include a web browser application, a ‘native’ application, or a ‘web widget’ which executes within a web-browser application. In a non-limiting embodiment, any combination of web-browser applications, native applications, or ‘web widgets’ may be used to facilitate data entry or modification or execution of a given trade or sale. In one example non-limiting embodiment of a ‘web widget’, a web-widget may facilitate the entry of wishlist information as a given user browses various web-sites using a web-browser hosted on computing device 150. The web widget would interact with Account Management module 331 for the purpose of adding or modifying wishlist data.

It is to be noted that while the term “user” is used frequently herein, it is to be understood that this represents a functional result of an underlying structure that is implied by the term “user”. Such an underlying structure can comprise accounts maintained within trading engine 190, and such accounts themselves include user identification and other profile information. Non-limiting examples of such will be discussed in greater detail below. In turn, such accounts can be accessed through different computing devices 150 by supplying appropriate credentials which are then authenticated at trading engine 190. Accordingly, the person skilled in the art is advised to read the term “user” so as to suggest an underlying technological structure, either according to the example given, or according to another technological construct within the scope of that skilled person, and which implements the notional concept of a user as that term is used herein.

Referring to FIG. 2, The processor 260 can further be configured to process interactions from the user (not shown) via the input module 215, which can be a keyboard, a mouse, a touch screen, a camera, a microphone, a barcode scanner, and/or the like. Thus, the user can direct the computing device 150 to perform specific functions via the input module 215. The processor 260 can further be configured to provide an output via the display 240. The display 240 can be any type of module for displaying information, for example, a liquid crystal display (LCD) monitor, a cathode ray tube (CRT) monitor, and/or the like. In some embodiments, the processor 260 can be configured to display content using an application, for example, a web browser. For example, the computing device 150 can be a computer operable to connect to the Internet.

The network 110 can be any type of network that can be accessed by interface modules (e.g., the interface module 270) directly or indirectly (i.e., via another network such as a cellular network or a Wi-Fi network). The network 110 can be implemented as a wired network and/or a wireless network. The network 110 can be, for example, a local area network (LAN), a wide area network (WAN), an intranet, a telecommunications network, the Internet, etc.

Referring to FIG. 1, as will be discussed in greater detail below, each server can be a remote source of data for and/or provide supplementary functionality to trading engine 190. For example, Social Network Server 120 can be a server hosting a social networking application such as Twitter™, Pinterest™, Facebook™ or LinkedIn™. Those skilled in the art will recognize that the noted social networking sites are merely indicative of a growing number of social network sites (many of which are segmented by interest and location)—a partial list of which are maintained by Wikipedia at http://en.wikipedia.org/wiki/List_of_social_networking_websites. E-Commerce/Barter Server 130 can be a server hosting e-commerce, marketplace, auction, classified, bartering services such as Ebay™, Etsy™, Craigslist™, Kijiji™, Facebook Marketplace™, and Swap.com™. Listings of products, merchandise, or services provided by services hosted on via E-Commerce/Barter Server 130 can be an optional source of data for trading engine 190. E-Mail Server 140 can be a server hosting webmail services such as Gmail™, or Yahoo! Mail or Hotmail™ as well as server based mail services such as Microsoft Outlook or Blackberry™ which allow trading engine 190 to communicate to computing device 150 via e-mail accounts. Messaging Server 160 can include messaging or communication services including instant messaging services such as Windows Live Messenger, Yahoo! Messenger or Google Talk—as well as communication services such as Skype or Google Voice. Payment Gateway Server 170 can be a server providing authorization and payment processing services to accommodate credit card, Interact™, automated clearing house (ACH), and other debit/direct payment transactions. Example payment gateway providers include PayPal™, Authorize.net™, PSiGate™, iTransact™, 2Checkout™, Versapay™, Google Checkout™. Those skilled in the art will recognize e-commerce payments can be facilitated by accessing the Payment Gateway Sever 170 by using an API (Application Programming Interface) or by redirecting a transaction to the website hosted by Payment Gateway Server 170. In the latter case, after the payment is processed, the transaction is returned or redirected back to the trading engine 190. Other services and functions provided by Payment Gateway Server 170 are generally described in the following Wikipedia article at http://en.wikipedia.org/wiki/Payment_gateway.

Referring now to FIG. 3, a schematic block diagram of certain components of trading engine 190 is depicted. It will now be apparent that each element of trading engine 190 depicted in FIG. 3 and discussed below can be embodied within the computer-readable instructions that comprise trading engine 190. In other words, functionality described below as being carried out by a certain module of trading engine 190 can be based on any known server environment. As such, each server including one or more processors, volatile (e.g. Random Access Memory (“RAM”)) and/or non-volatile (e.g. read only memory (“ROM”), Electrically Erasable Programmable Read Only Memory (“EEPROM”), flash memory, magnetic computer storage device, or optical disc) memories and a network interface/API Layer 310 for interconnecting with network 110 via link 191.

Trading engine 190 can include a logic layer 330, data layer 350, network interface/API layer 310, and presentation layer 320. Network interface/API layer 310 enables interaction between the logic layer 330, data layer 350, presentation layer 320, and network 110. The individual layers of trading engine 190 are collectively referred as layers. That is, network interface/API layer 310 enables interaction between the layers and modules of trading engine 190 as well as applications and services hosted by servers accessible as well as computing devices 150 via network 110. Not all the linkages between the modules and layers of trading engine 190 are shown in FIG. 3. Presentation layer 320 can include various modules for interacting with applications and services hosted by servers or computing devices 150 accessible via network 110. For example, presentation layer 320 can include a website module 321 for enabling interactions with a browser application of computing device 150. Those skilled in the art will recognize that a number of protocols (e.g. HTTP, HTTPS, TCP/IP, SMTP etc.) and Application Programming Interfaces can be used independently or in combination to effect the transfer of data between the layers and modules of trading engine 190 and the applications and services hosted by servers or computing devices 150 accessible via network 110.

Logic layer 330 can include an account management module 331, a matching module 332, a search module 333, a trade execution module 334, a post extraction and conversion module 335, a social network integration module 336, a trade circle management module 337, a communications module 338, an offer management module 339, charging module 340, and engagement module 341. The functions of the various exemplary modules of logic layer 330 will be discussed below in greater detail.

The account management module 331 is generally configured to maintain and manage the underlying structure for account data and profile information that collectively comprises an account for “users” of trading engine 190. The data maintained by account management module 331 includes data specific to trading engine 190 including, but not limited to, log-in credentials, profile information, wishlist information (data pertaining to items desired by a given user of trading engine 190 (e.g. “used laptop”, “SLR Camera”, “black leather jacket”), interests (data pertaining to areas of interest of a user of trading engine 190 which may be used to facilitate matching by matching module 332 and search by searching module 333 (e.g. “gardening”, “cinematography”, “aviation”, “travel”)), target trading goal information (e.g. data pertaining to a single target or end goal of a user of trading engine 190 (e.g. the “Kiinzel Dream”)), offer information, statistical information (e.g. number of successful trades or purchase/sell transactions completed, number of successful trades or purchase/sell transactions in a given category, number of successful trades or purchase/sell transactions associated with an engagement category) as well as contextual data such as the current location of a user of trading engine 190. Note that interest data can cover more than one product category (e.g. “cinematography” can be associated with photo and video equipment as well as literature pertaining to the creation of photographs and films). The data maintained by account management module 331 also includes, but is not limited to, one or more account identifiers, log-in names or other credentials and information to access, send, or retrieve data from applications and services hosted by servers accessible via network 110. The account management module 331 can also acquire and manage data pertaining to any prescribed preferences associated with a user of trading engine 190 as well as preferences associated with other modules in the logic layer 330. For example, the account management module 331 can acquire and manage data pertaining to social network applications or sites, e-mail accounts, and messaging services including the applicable name, address information (e.g. internet addresses or URLs), and log-in information (e.g. identifier and password). Such account management data can also include any other prescribed information pertaining to how or when to access a contact information source (for example, whether to access a contact information source at a specified time or frequency). Account management module 331 can maintain the above-described account management data for each application and service hosted by servers accessible via network 110. The data maintained by account management module 331 may also include attributes associated with facilitating communications (e.g. e-mail addresses, Twitter™ identifiers etc.) to facilitate communication to users of trading engine 190 via E-Mail Server 140 or Messaging Server 140 or to import social data including social graph information via one or more social network applications and services hosted by Social Network Server 120 accessible via network 110. Other social data may include interests, groups, recent posts, pictures, personal information (e.g. affiliations, birthdate, schools attended etc.), as well as any other information the user has elected to share. Data maintained by account management module 331 along with other notification-related configurable settings, can be accessed and managed from computing device 150 (e.g. via a web browser interface).

Wishlist data can be either directly entered by a user of trading engine 190 via computing device 150 (e.g. via a web-browser). Alternatively, a user of trading engine 190 can link the wishlist to an existing offer provided by another user of trading engine 190 by selecting a wishlist icon, button, or other indicator as displayed in connection with an offer via computing device 150. In the latter scenario, stored and displayed wishlist data may include a description of the offer as well as a link to the offer. In the latter scenario, as the state of an offer is modified (e.g. a given offer is traded or an offer is removed), the stored and displayed wishlist information is modified or deleted. For example, in the event that an offer is traded and relisted, wishlist link information would point to an offer associated with the current owner of the given offer. In the event that an offer is traded and not relisted or in the event that an offer is deleted, wishlist data including link information would be deleted from the wishlist associated with the given user of trading engine 190.

The matching module 332 is generally configured to parse, filter, index, and correlate offer to wishlist data for the purpose of highlighting items of interest (including offers or informational articles) or proposing trades or transactions between two or more users of trading engine 190 given offer, wishlist, interest, derived or imported social data including social proximity, and other data maintained by trading engine 190. Although matching module 332 can be invoked for the purpose of proposing trades between two users of trading engine 190, matching module 332 can propose suggested optimal trades between 3 or more given users of trading engine 190. In the latter scenario, matching module 332 would determine the intermediate trades between the 3 or more users of trading engine 190 so that the 3 or more given users of trading engine 190 would progress in terms of fulfilling their wishlist or completing their target goal. The matching module 332 would notify affected users of trading engine 190 of the proposed trade scenario via communications module 338. Users may elect to execute the trades proposed by matching module 338 by invoking the trade execution module 334. Alternatively, upon confirmation from the affected users of trading engine 190, matching module 332 may invoke trade execution module 334 to undertake associated trades recommended by matching module 332. Parsing includes lexical and syntactic analysis of offer and wish list data whereby the offer and wish list data is associated into objects or tokens (also referred to herein as “attributes”) such as category, product type, product information. Matching module 332 includes a filtering function which is configured to discard data that are deemed to be irrelevant, to merge duplicate data, or any suitable combination of such functions. Matching module 332 also includes an indexing function configured to identify and correlate wishlist and offer data based on attributes as well as other variables (e.g. relative age of offer or wishlist information). It is to be contemplated that a variety of algorithms (e.g. expert systems, neural net based systems, and inference engines) and data structures can be used to implement the above-mentioned functions of matching module 332. It is also to be contemplated that multiple parsing, filtering, identification and indexing methods can be used in parallel or as a function of the source of the offer and wishlist data. The operation of matching module 332 is configurable by operational parameters provided by the user (or module) as well as operational parameters maintained by and updated via account management module 331. For example, the operation of the matching module 332 can be affected by the social proximity between users (e.g. whether an offer is associated with a user's trading circle).

The search module 333 is generally configured to search for data contained in the data layer 350 based on attributes or keywords (e.g. offer information such as “smartphone”). A search can be explicitly invoked by a user of trading engine 190 or invoked autonomously by a module of trading engine 190 (e.g. to suggest potential trades or transactions based on wishlist data or interests associated with a given profile). The search module 333 can synthesize a summary of relevant information which can be displayed on a computing device 150 (e.g. via a web browser) or directed to a designated application or service (e.g. via an e-mail address via E-Mail Server 140) that can accessed via communications device 150. It is to be contemplated that a variety of algorithms (e.g. indexing, data mining, pattern matching, web-crawling) can be used to implement independently or in combination to effect the above-mentioned functions of search module 333. The operation of search module 333 is configurable by operational parameters provided by the user (or module) in connection with a given search as well as operational parameters maintained by and updated via account management module 331. For example, information provided by the search module 333 can specifically be affected by whether the user selects a given date range, whether a given user elects to search for offered items within a given social proximity (e.g. within a user's trading circle), offer/listing popularity (e.g. the number of times an offer has been liked, has been wishlisted, has been shared via social media networks), recency of the offer, relative geographic proximity between users of trading engine 190 etc.

The trade execution module 334 is generally configured to execute a trade or purchase transaction as well as accommodates for exception events (e.g. trade offer rejected). In a non-limiting embodiment, the trade execution module 334 accepts a proposed trade transaction from a given user (‘offerer’) of trading engine 190 includes an offered item and a proposed item to be acquired in exchange for the offered item associated with a different user (‘offeree’) of trading engine 190. In another non-limiting embodiment, the trade execution module 334 accepts a proposed purchase price from a given user (‘offerer’) of trading engine 190 in exchange for the offered item associated with a different user (‘offeree’) of trading engine 190. In yet another non-limiting embodiment, a proposed trade transaction may include a combination of an offered item(s) as well as financial consideration (e.g. money). The trade execution module 334 may optionally accept additional notes or commentary in connection with a proposed trade transaction. The trade execution module 334 will invoke the communications module 334 to communicate the proposed offer to the offeree of trading engine 190. The offeree of trading engine 190 may accept, reject, or counter the proposed offer from the offerer of trading engine 190. In the event that the offeree user of trading engine 190 accepts the offer, the trade execution module 334 communicates the acceptance of the offer to the offerer of trading engine 190 via communications module 338. The trading engine 190 may request both the offeree and offerer of trading engine 190 to provide feedback and/or review information with respect to the trade via communications module 338. In the event the offeree of trading engine 190 rejects the offer, the trade execution module 334 communicates the rejection of the offer to the offerer via communications module 338. In the event of a rejected trade or purchase transaction, the trade execution module 334 may optionally accept additional notes or commentary in connection with a rejected trade or purchase transaction to be communicated to the offerer. In the event that the offeree of trading engine 190 counters the offer, the trade execution module 334 communicates the parameters of the countered offer to the offerer of trading engine 190. In the event of a counter offer, the trade execution module 334 may optionally accept additional notes or commentary in connection with a proposed counter transaction to be communicated to the offerer. In the event of a counter offer, offerer may accept, reject, or counter the offer. This sequence of counter offers may continue until acceptance or rejection of either party associated with a proposed trade or purchase transaction. In the event that either party does not respond to a proposed offer for a period of time, the trade execution module 334 may autonomously withdraw the proposed trade or purchase offer and communicate the withdrawal of the offer to the offeree and offerer via communications module 338. Upon a successful trade or purchase transaction, the trade execution module 334 may inform the charging module 340 for the purpose of applying any associated charges to either the offeree or offerer. In addition, upon a successful or unsuccessful trade or purchase transaction the trade execution module 334 may update the profiles of the offeree and offerer via the account management module 331 as well as modify/delete the applicable offers via the offer management module 339. Applicable profile updates via the account management module 331 and engagement module 341 may include a change in state relative to the target goal as well as updates to statistical information pertinent to a given user of trading engine 190 (e.g. number of successful trades or purchase/sell transactions completed, number of successful trades or purchase/sell transactions in a given category, number of trades or purchase/sell transactions associated with an engagement counter etc.).

The post extraction and conversion module 335 is generally configured to access and retrieve listing information from services and applications hosted via E-Commerce/Barter Server 130. The post extraction and conversion module 335 will convert any applicable listing data so that it is compatible with the data structure and format maintained by the data layer 350 of trading engine 190. Those skilled in the art will recognize that a variety of methods may be used to access and retrieve listing information from services and applications hosted via E-Commerce/Barter Server 130 including but not limited to the use of an API provided by a given service and application as well as ‘web scraping’ techniques as generally described in the following Wikipedia article at http://en.wikipedia.org/wiki/Web_scraping. The post extraction and conversion module 335 may use the communication module 338 to prompt users via communications device 150 to remove listing information from services and applications hosted via E-Commerce/Barter Server 130 to avoid confusion or potential conflicts. Alternatively, post extraction and conversion module 335 may autonomously remove listing information from services and applications hosted via E-Commerce/Barter Server 130 to avoid confusion or potential conflicts.

The social network integration module 336 is generally configured to access services and applications hosted via Social Network Server 130 for the purpose of authenticating a user's identify and credentials with respect to a given social network application or service hosted via Social Network Server 130. The social network integration module 336 may also access services and applications hosted via Social Network Server 130 for the purpose of accessing and retrieving profile and social data including social graph data (e.g. friends, colleagues, group lists). Other social data may include interests, recent posts, pictures, personal information (e.g. affiliations, birthdate, schools attended etc.), as well as any other information the user has elected to share. Data accessed and retrieved via the social network integration module 336 may optionally be used by the account management module 331 to update a user's profile or to facilitate the creation or expansion of a given user's trading circle via the trading circle management module 337. Social data accessed and retrieved via the social network integration module 336 may optionally be used by the matching module 332 to highlight items of interest (including offers or informational articles) or propose trades or transactions between two or more users of trading engine 190. The communication module 338 may optionally invoke the social network integration module 336 to post information pertinent to an offer, trade, or user of trading engine 190 to a given service and application hosted via Social Network Server 130 for the purpose of communicating the status of an offer, trade, or user of trading engine 190 within a given user's social networks as maintained by social network applications or services hosted via Social Network Server 130.

The trading circle management module 337 is generally configured to create and maintain a list of preferred trading users (accounts) for a given user (account). The trading circle management module 337 may optionally invoke the social network integration module 336 in order to facilitate the creation, modification, or expansion of a given user's trading circle. In an embodiment of the invention, the trading circle management module 337 will calculate the degrees of linkages (‘distance’, ‘degrees of separation’ or social proximity) between users of trading engine 190. The degrees of separation may be optionally be displayed upon viewing a given user's information (e.g. on a user's profile page, in connection with a message from a user, or in connection with a user's offer). The modules of trading engine 190 may be configured such that trading circle data may be used to filter or affect the operation of a search, match, or trade associated with trading engine 190. In an optional embodiment of the invention, the modules of trading engine 190 may be configured so that the operation of search, match, or trade functionality associated with trading engine 190 is affected by the social proximity (distance) between trading circles associated with users of trading engine 190.

The communications module 338 is generally configured to maintain and effect messages between users of trading engine 190 or autonomously generate notifications by modules of trading engine 190 (e.g. messages or notifications associated with the state of an offer or trade as well as engagement notifications). The communications module 338 may communicate messages and notifications so that they can be accessed and managed from computing device 150 (e.g. via a web browser interface). The communications module 338 may optionally communicate messages and notifications via services and applications hosted by Social Network Server 120, E-Mail Server 140, or Messaging Server 160.

The offer management module 339 is generally configured to create, modify, and delete data and attributes of offers associated with a given user of trading engine 190. The offer management module 339 may utilize the presentation layer 320 so that visual information (e.g. one or more pictures) as well as descriptive information (e.g. product category (e.g. “photography equipment”) and other information to describe the product and any other potentially pertinent details (e.g. “Canon Rebel T3” (to identify the product) and “Got this camera for my birthday. It's just too complicated for me! I just used it a couple of times. Looking to trade for something simpler.” (to provide information on the state or condition as well as any other context associated with the product)) associated with an offered item or service can be accessed and managed from computing device 150 (e.g. via a web browser interface). In a non-limiting embodiment, the attributes may include the offerer's preference for a trade, financial consideration (e.g. via a price), or a combination of a trade and financial consideration. A user may optionally invoke the post extraction and conversion module 335 for the purpose of facilitating the completion of one or more offers. A user may optionally provide attributes or tags associated with a given item or (e.g. “Canon”, “SLR Camera”, “12+ Megapixels”) in order to facilitate searching for a given offer or matching between wishlists and offers. In an embodiment of the platform, the offer management module 339 may autonomously extract or determine relevant tags associated with a given offer. In the previously noted embodiment of the platform, the autonomously extracted and determined tags may supplement any explicitly provided tags provided by a user of trading engine 190.

The charging module 340 is generally configured to determine and apply the applicable charge in connection with the use of trading engine 190. In a non-limiting embodiment, the charging module 340 facilitates the transfer of payments between users of trading engine 190 in connection with a given transaction. The associated rates and charges are configurable and may include a charge per completed trade or transaction, a charge per completed trade or transaction once a threshold is reached over a given period of time, a charge for the invocation of an optional feature, or a charge that is applied at periodic intervals of time for using one or more aspects of trading engine 190. The charging module 340 may apply the charge to a given user via a service or application hosted via Payment Gateway Server 170. Certain aspects of the operation of charging module 340 are configurable by operational parameters provided by the user via account management module 331 (e.g. identity and credential information associated with a given payment account).

The engagement module 341 is generally configured to monitor selected statistical information as maintained by counters in connection with the utilization of trading engine 190 as maintained by account management module 330. For example, the number of successful trades or transactions in connection with a given category or the number of successful trades or transactions over a given period of time. The engagement module 341 may monitor statistical information that is not directly associated with a trade or transaction. For example, the number of times a user has communicated the availability of an offer via a social network application or service. Upon reaching threshold limits, the engagement module 341 may invoke the communications module 338 to notify a user of trading engine 190 with a message to encourage further utilization of trading engine 190. The engagement module 341 can synthesize a summary of relevant statistical information which can be displayed on a computing device 150 (e.g. via a web browser (e.g. via the presentation of counters and/or associated ‘badges’)) or directed to a designated application or service (e.g. via an e-mail address via E-Mail Server 140) that can accessed via communications device 150. In an optional embodiment of the platform, upon reaching threshold limits, the engagement module 341 can apply a promotion via charging module 340 (e.g. to provide certain chargeable functions of trading engine 190 at a discounted level). In an embodiment of the platform, upon reaching threshold limits, the engagement module 341 can either fully or partially reset one or more counters via the account management module 331. The engagement module 341 also calculates a rating or score for users of trading engine 190 based on an algorithm. It is to be contemplated that the algorithm will establish the rating or score based on a number of statistical metrics associated with the use of trading engine 190 (e.g. based on the number of transactions, positive or negative feedback received, number of trades or purchase/sell transactions etc.) as well as other information determined in connection with the use of trading engine 190 (e.g. semantic/sentiment analysis of provided review text for a given trade or purchase/sell transaction etc.). The rating or score determined by engagement module 341 will increase engagement, credibility, and trust for users of the platform by providing a quantified or qualified (e.g. a visual indicator that can be displayed on computing device 150 (e.g. via a web-browser)) that provides an indication of the reputation of a given user of the trading engine 190. The rating or score determined by the engagement module 341 will be maintained by the account management module 331. The operation of engagement module 341 is configurable (e.g., the threshold limits associated with a given counter, the message to be conveyed to a user of trading engine 190, and any other actions in connection with reaching a threshold limit).

Although the above-mentioned modules are described individually, it is to be contemplated that the functionality of any given selection of modules, or of all modules, can be combined within logic layer 330.

Data layer 350 is generally configured to manage the storage of trading data associated with trading engine 190. Trading data can comprise profiles 351 (e.g. user identity data, e-mail credentials and login data, profile pictures, social network credentials, payment service provider credentials, statistical information (number of successful trades or purchase/sell transactions, number of successful trades or purchase/sell transactions in a category, number of trades associated with an engagement counter etc.), configuration data pertaining to the operation of trading engine 190 etc.), offers 352 (e.g. item category, item pictures, descriptive information), trades 353 (e.g. data pertaining to pending trades or purchase/sell transactions, log of successful trades or purchase/sell transactions, reviews associated with each trade or purchase/sell transaction), trading goals 354 (data pertaining to the primary trading objective of a user (e.g. pictures, descriptive information), and trading circles 355 (preferred trading users for a given user). It will be apparent that although trading data (e.g. profiles, offers, trades etc.) are shown as being maintained separately, any suitable storage, data structure, and indexing scheme can be used to maintain data.

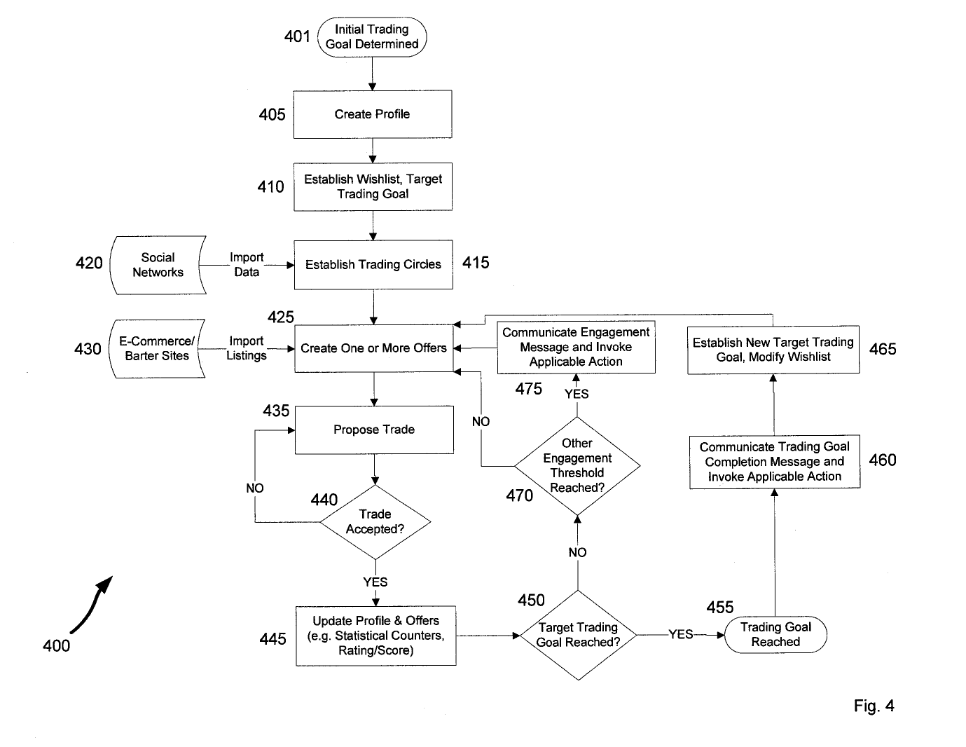

Referring now to FIG. 4, a method 400 of managing and executing trades or purchase/sell transactions as well as associated data (e.g. profile and offer data) will be described in conjunction with its performance in system 100. It will be appreciated, however, that method 400 need not be performed exactly as discussed herein. For example, the individual blocks can be performed in different sequences for the purpose of updating data or to execute trades. In addition, it will be appreciated that method 400 can be performed in systems other than system 100. It will be evident that any combination of web-browser applications, native applications, or ‘web widgets’ hosted by computing device 150 may be used to facilitate the entry or modification of data or the execution of a trade for method 400.

Beginning at 401, a user of trading engine 190 determines an initial trading goal. The trading goal is notionally a target objective that a user will generally require several trades or purchase/sell transactions to complete (although the trading goal can potentially be completed in one trade).

At block 405, a user of trading engine 190 creates a profile. The profile may include credentials for trading engine 190 as well as applications and services hosted by servers or computing devices 150 accessible via network 110. The profile may also include descriptive information pertaining to the user of trading engine 190 (e.g. the user's picture and other descriptive information). Other personal and contextual information may be supplied by the user for the purpose of creating a profile.

At block 410, the profile of a user of trading engine 190 is supplemented with wishlist and target trading goal data. Wishlist data consists of descriptive information pertaining to one or more desired items and may include text, pictures, and/or attributes. Trading goal data consists of descriptive information pertaining to a target objective and may include text, pictures, and/or attributes.

At block 415, data pertaining to the trading circles of a user of trading engine 190 is acquired. Trading circle data includes identity information pertaining to other users of trading engine 190 that a given user has a preferred trading relationship with. Trading circle data may impact the operation of various modules of trading engine 190. For example, search module 333 may provide results for offered items associated with members of a given user's trading circle, matching module 332 may provide matches between wishlist and offer data associated with members of a given user's trading circle. The modules of trading engine 190 may be configured such that trading circle data may be used to filter or affect the operation of a search, match, or trade associated with trading engine 190. In an optional embodiment of the invention, the modules of trading engine 190 may be configured so that the operation of search, match, or trade functionality associated with trading engine 190 is affected by the social proximity (distance) between trading circles and other social data (e.g. explicitly stated or derived interests or sentiment) associated with users of trading engine 190.

At block 420, identity and other data associated with a given user's social graph on social network applications may be imported via Social Network Server 120. Those skilled in the art will recognize that a variety of methods may be used to access and retrieve information from services and applications hosted via Social Network Server 120 including but not limited to the use of an API provided by a given service and application as well as ‘web scraping’.

At block 425, a user of trading engine 190 enters data pertaining to one or more offers. An offer includes descriptive information pertaining to an item that a user of trading engine 190 is willing to trade or sell and may include text, pictures, and/or attributes. At block 430, data associated with listings associated with services and applications hosted via E-Commerce/Barter Server 130 may be imported and converted for the purpose of facilitating the creation of one or more offers. Those skilled in the art will recognize that a variety of methods may be used to access and retrieve listing information from services and applications hosted via E-Commerce/Barter Server 130 including but not limited to the use of an API provided by a given service and application as well as ‘web scraping’. Information pertaining to an offer may be communicated via a given service and application hosted via Social Network Server 130 within a given user's social networks as maintained by social network applications or services hosted via Social Network Server 120 accessible via network 110.

At block 435, an offerer of trading engine 190 proposes an offer includes an offered item and a proposed item to be acquired in exchange for the offered item associated with an offeree of trading engine 190. In a non-limiting embodiment, an offerer of trading engine 190 proposes a financial consideration in the form of a proposed purchase price for the offered item associated with an offeree of trading engine 190. In yet another non-limiting embodiment, an offerer of trading engine 190 proposes an offer including a combination of an offered item(s) as well as financial consideration for the offered item associated with an offeree of trading engine 190. A user may have identified a given offer of interest by viewing the offer information listed on a profile page of another user of trading engine 190. Alternatively, a user may have identified a given offer of interest by using the search function provided by search module 333. In an alternative embodiment, trading engine 190 may autonomously suggest a proposed trade by correlating available offer and wishlist information of users of trading engine 190 via matching module 332.

At block 440, the offeree accepts or rejects the proposed offer (trade and/or proposed purchase). If a proposed offer is rejected, the method returns to block 435. If a proposed offer is accepted, the method progresses to block 445. Those skilled in the art will recognize that a variety of methods may be used to communicate the proposal and acceptance of an offer via web-browser applications, native applications, or ‘web widgets’ hosted by computing devices 150 associated with the offerer and offeree. For example, the communications module 338 may send a notification message of a proposed trade (or purchase) which can be displayed on a computing device 150 (e.g. via a web browser) or directed to a designated application or service (e.g. via an e-mail address via E-Mail Server 140 or via a messaging identifier via Messaging Server 160) that can accessed via communications device 150. Similarly, a given user can invoke an action via an input module 215 to indicate the acceptance or rejection of a proposed transaction in conjunction with a web-browser application, native application, or ‘web widget’ hosted by computing device 150. The acceptance or rejection of an offer would be directed to trading engine 190 via Network 110 and processed by communications module 338. It will be evident to those skilled in the art that a number of scenarios may affect method 400 and alter the progress of method to a given block [not shown]. For example, the offerer may elect to terminate the offer process. Alternatively, the offeree may accept an offer from an alternative offerer or the offeree may remove a given offer.

At block 445, applicable information pertaining to the offerer and offeree is updated. For example, offer information or items of a given user's wishlist may be modified or deleted. With respect to wishlist information, in the event that an offer is traded (or sold) and relisted, wishlist link information would point to an offer associated with the current owner of the given offer. In the event that an offer is traded (or sold) and not relisted, wishlist data including link information would be deleted from the wishlist associated with the given user of trading engine 190. In addition, applicable statistical counters are updated for each affected user (e.g. the number of successful trades or purchase/sell transactions, the number of successful trades or purchase/sell transactions in connection with a given category or the number of successful trades or purchase/sell transactions over a given period of time). In addition, the engagement module 341 determines the new rating or score associated with the offerer and offeree. Information pertaining to the trade or purchase/sell transaction may be communicated via a given service and application hosted via Social Network Server 130 within a given user's social networks as maintained by social network applications or services hosted via Social Network Server 120 accessible via network 110.

At block 450, the engagement module 341 determines if a given user's target trading goal has been achieved. If the target trading goal has not been achieved, the method progresses to 470. If the target trading goal has been achieved, the method progresses to 455.

At block 455, the trading goal of a given user has been achieved. The method progresses to block 460.

At block 460, engagement module 341 communicates a congratulatory message associated with the completion of trading goal to the applicable user of trading engine 190 via communications module 338. In addition, applicable actions are invoked including, but not limited to, updating information on the applicable user's profile (e.g. updating a counter which would invoke the display of a ‘badge’ via a web-browser application, native application, or ‘web widget’ hosted by computing device 150), the modification or deletion of the trading goal objective associated with the applicable user of trading engine 190, the application of a charge or promotion via charging module 340, the communication of the user's achievement via one or more social network applications and services hosted by Social Network Server 120 accessible via network 110. The method progresses to block 465.

At block 465, a user of trading engine 190 establishes a new target trading goal. The user may also modify other data pertaining to the profile including, but not limited to, wishlist data. The method returns to block 425.

At block 470, the engagement module 341 determines if a given user's other engagement thresholds have been achieved (e.g. number of trades or purchase/sell transactions in a given product category, number of times a user has communicated the availability of an offer via a social networking application or service). If an engagement threshold has not been achieved, the method returns to 425. If one or more engagement thresholds have been achieved, the method progresses to 475.

At block 475, engagement module 341 communicates a message associated with the attainment of a threshold engagement level to the applicable user of trading engine 190 via communications module 338. In addition, applicable actions are invoked including, but not limited to, updating information on the applicable user's profile (e.g. updating a counter which would invoke the display of a ‘badge’ via a web-browser application, native application, or ‘web widget’ hosted by computing device 150), the application of a charge or promotion via charging module 340, the communication of the user's achievement via one or more social network applications and services hosted by Social Network Server 120 accessible via network 110. The method progresses to block 425.

It is to be understood that the foregoing present certain exemplary embodiments, but modifications, variations, subsets and/or combinations thereof are to be contemplated. For example, it is to be understood that system 100, trading engine 190 and method 400 may be modified to also support the purchase of items or a combination of a trade and payment in connection with a given transaction associated with system 100, trading engine 190 and method 400. In the latter embodiment, charging module 340 will use the payment and charging applications and services hosted by Payment Gateway Server 170 accessible via network 110 for the purpose of initiating a payment or exchange of funds between users of trading engine 190.

In other embodiments, method 400 can be modified to support trades between 3 or more users of trading engine 190. In the latter scenario, matching module 332 would determine the intermediate trades between the 3 or more users of trading engine 190 so that the 3 or more given users of trading engine 190 would progress in terms of fulfilling their wishlist or completing their target goal. The matching module 332 would notify affected users of trading engine 190 of the proposed trade scenario via communications module 338. Users may elect to execute the trades proposed by matching module 338 by invoking the trade execution module 334. Alternatively, upon confirmation from all of the affected users of trading engine 190, matching module 332 may invoke trade execution module 334 to undertake associated trades recommended by matching module 332.

In some embodiments, the resources (e.g. memory and processor) and functionality of servers and trading engine 190 may be partially or entirely distributed via one or more computing devices or servers in a construct known as a ‘cloud’ or ‘cloud computing’ as generally described by Wikipedia at http://en.wikipedia.org/wiki/Cloud_computing. For example, with reference to method 400, resources can be distributed among several computing devices and servers with processing of method 400 being coordinated by methods and algorithms well known by those skilled in the art. It is also to be contemplated that in some embodiments, that servers and associated applications may be provided via cloud computing methods and practices. Persons skilled in the art will appreciate that there are yet more alternative implementations and modifications possible for implementing the embodiments, and that the above implementations and examples are only illustrations of one or more embodiments.

I claim:

1. A computer implemented trading engine configured to connect with a plurality of computing devices and a plurality of servers; said trading engine further configured to manage trading circles between accounts maintained in association with at least two of said computing devices, said engine trading further configured to manage a first electronic data message representing at least one offer and at least one additional electronic data message representing an accepted trade proposal for said at least one offer.

2. The engine of claim 1 wherein said at least one offer and said accepted trade proposal represent non-pecuniary items.

3. The engine claim 1 wherein said engine is further configured to update a trading goal profile in response to said accepted trade proposal.
